(19) United States
(12) Patent Application Publication
(10) Pub. No.: US 2018/0263438 A1
(43) Pub. Date: Sep. 20, 2018

(54) SLIDING LOCKING NUT DEVICE

(71) Applicant: Alan Verchick, Boulder City, NV (US)

(72) Inventor: Alan Verchick, Boulder City, NV (US)

(21) Appl. No.: 15/926,163

(22) Filed: Mar. 20, 2018

Related U.S. Application Data
(60) Provisional application No. 62/601,350, filed on Mar. 20, 2017.

(51) Int. Cl. A47K 13/26; F16B 21/00

(52) U.S. Cl. CPC A47K 13/26; F16B 21/00

(57) ABSTRACT

A device having a base portion operable for accepting a bolt, an interior chamber disposed within the base portion, a compression sleeve disposed within the interior chamber, wherein the compression sleeve is operable for compressing about the circumference of the bolt. A lever implement is operable for at least one of, compressing and relaxing the compression sleeve, wherein a lifting of the lever implement relaxes the compression sleeve, and wherein depressing the lever implement toward the base portion compresses the compression sleeve to constrict upon the inserted bolt and generally secure said inserted bolt.

### CROSS- REFERENCE TO RELATED APPLICATIONS

The present Utility patent application claims priority benefit of the [U.S. provisional application for patent Ser. No. 62/601,350 entitled “Sliding Locking Nut”, filed on Mar. 20, 2017, under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable

### INCORPORATION BY REFERENCE OF SEQUENCE LISTING PROVIDED AS ATEXT FILE

Not applicable

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to fastening mechanisms. More particularly, certain embodiments of the invention relates to a locking mechanism that can take the place of a standard securing nut, and which can be applied to and removed from a hosting bolt without tools.

A typical prior art toilet seat has a liftable cover which rests against a front face of a water tank which are hinged and bolted to a toilet bowl through hinge attachment holes in the rear ledge of the toilet bowl. In general, toilet seat assemblies may be permanently affixed to the top of the toilet bowl. As a result from the permanent fixture of the toilet seat is that in order to clean the toilet, one may have to clean around the hinge assembly and under the raised toilet seat and cover. The task of cleaning a toilet bowl may be objectionable when one has to reach underneath the raised seat and clean around the attached hinges.

In some instances, a conventional hinge mechanism may be designed in such a manner that the toilet seat and the lid may be removed from a toilet bowl for the purpose of cleaning. The hinge pin may be detachably press-fitted in a bore of the housing. However, removal of the hinge pin in an attempt to remove the toilet seat and lid may require the use of a tool such as a pair of pliers and screw drivers. This may be difficult for an ordinary user, such as a housewife, to remove the hinge pin in the course of routine household chores.

In other instances, during installation of a toilet seat, it may be inconvenient and time-consuming when applying nuts and bolts in restricted areas. It may be costly because too often multiple units are needed before the task is complete. Nuts and bolts may be easily cross-threaded during the process. It may be hard to see the materials in use when working in a limited space. The nut may be easily misapplied or become jammed on the bolt. The threads of the bolt may be easily stripped, as well as damage the nut.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. It may be desirable to secure a detachable member to a stationary member in a way that substantially engages the detachable member but also allows the detachable member to be separated from and re-attached to the stationary member.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that it is typical to convert a conventional toilet seat into a removable toilet seat by simply replacing the conventional fastener with a special fastener which permits the seat to be easily detached, without requiring any modification to either the seat or the toilet bowl. The conventional fastener is generally employed for detachably connecting first and second members, such as a toilet seat and a toilet bowl. The conventional fasteners which are normally installed through seat mounting holes in the toilet bowl and in the toilet seat are replaced with detachable fasteners which use the same mounting holes. One end of an outwardly extending pin is secured to each mounting hole in the toilet seat, and a mounting receptacle is attached to each corresponding mounting hole in the toilet bowl.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an exemplary sliding locking nut device, in accordance with an embodiment of the present invention;

FIG. 2 is an illustration of an exemplary device base, in accordance with an embodiment of the present invention;

FIG. 3 is an illustration of an exemplary compression sleeve, in accordance with an embodiment of the present invention;

FIG. 4 is an illustration of an exemplary device lever, in accordance with an embodiment of the present invention;

FIG. 5 is an illustration of an exemplary see-thru view of the device, wherein the lever is in the UP position, in accordance with an embodiment of the present invention;

FIG. 6 is an illustration of an exemplary see-thru view of the device, wherein the lever is in the DOWN position, in accordance with an embodiment of the present invention;

FIG. 7A and FIG. 7B is an illustration of an exemplary sliding locking nut device upon a bolt, in accordance with an embodiment of the present invention; and

FIG. 8 is an illustration of an exemplary sliding locking nut device in use attaching a toilet seat to a toilet bowl, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them- Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn. 112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

In one embodiment, the Sliding Locking Nut Device is a locking mechanism that may take the place of a standard securing nut, and which may be applied to and removed from a hosting bolt without the need of tools. The device may simplify the installation process, may take less time for its completion, and provides significant convenience to this task when done within confined areas. Unlike standard securing nuts, the Sliding Locking Nut Device may be absent of risk of unintentional loosening. The Sliding Locking Nut Device may be comprised of a nut of cylindrical shape, and that may feature a compression sleeve within the interior chamber of the device. A lever implement may affix to the exterior of the device and may attach to the interior compression sleeve via an extending tab that may project through an open column of a base portion of the device. Pins may attach the lever implement to a permanent extending bracket featured at one end of the device, and also to that extending tab of the compression sleeve. To use the Sliding Locking Nut Device, one may simply slide the device upon a bolt to a necessary depth, then depress the lever implement. The lever depression may constrict a sidewall of the compression sleeve, creating needed tension, and even pull the bolt downward into the Sliding Locking Nut Device, furthering its secure attachment. No tools may be needed for its application. The Sliding Locking Nut Device may be applied upon bolts that are in contained, restricted, and difficult to reach locations, and that ordinarily may take much time and strain to apply using traditional techniques.

In some embodiments, the Sliding Locking Nut Device may include a base portion in the format of a cylindrical sliding nut, an open column (or slot) in one (1) lengthwise wall of the device, and a compression sleeve within the interior of the device. A permanent extending bracket is disposed on the top plane of a vertical wall of the base. A lever attaches to both this bracket and an extending tab of the compression sleeve by use of a connecting rod. Pins (or fasteners) may secure the lever to the base, to the connecting rod, and to the compression sleeve.

In some embodiments, the base portion of the Sliding Locking Nut Device may include a nut in the format of a hollow cylindrical column, may be made of, but not limited to, a nylon polyamide (PA) material. A flange may be disposed about the circumference of one (1) end of the device. On the same endpoint of the device (as the flange), there may be included an extending bracket. An aperture may be featured through this bracket. Directly below the extending bracket is an open length-wise column. The interior chamber of the device may include a compression sleeve, which may be made of, but not limited to, neoprene, and in a conical shape that narrows towards the aperture of the base that is at the opposite endpoint of the flange. Extending from the compression sleeve, and through the column of the base portion, is a tab, which may be made of, but not limited to, nylon polyamide (PA). For attachment to the bracket that may extend from the top area of the base portion of the Sliding Locking Nut Device may comprise a lever, which may be made of, but not limited to, nylon polyamide (PA) material. The top point of the lever may include a bracket, which is sized in length and width for its application upon the bracket on the base portion of the device. The bracket of the lever may feature two (2) axles, the topmost of which may connect to the bracket of the device by a pin. A rod, which may be made of, but not limited to, the same nylon polyamide (PA) material, may connect by pin to the remaining axle of the lever at one (1) end, and the opposite end of this rod may connect to the tab of the compression sleeve by a pin. The pins may be made of, but not limited to, a hardware-grade steel.

In other embodiments, the Sliding Locking Nut Device may be applied and secured upon hosting bolts simply by hand. It may be applied to bolts in contained areas of limited space. It may secure upon bolts much easier than ordinary nuts. It may secure upon bolts much faster than ordinary nuts. It may reduce the time required to apply nuts to bolts. By reducing the time required to apply nuts to bolts, the Sliding Locking Nut Device may allow relevant tasks to be completed faster, may reduce the labor cost of its user, may improve the productivity of its user, and may allow inexperienced users to complete tasks. The use of the Sliding Locking Nut Device may avoid damaging bolts, such as by unintentional cross-threading, and it is not subject to damage from tools, such as stripping.

In additional embodiments, the Sliding Locking Nut Device may be made in various sizes and shapes to ensure its use on specific bolts of various lengths and diameters. The base, rod and lever of the device may be made of various plastic materials of adequate durability, such as but not limited to, nylon polyamide (PA), polycarbonate (PC), and acrylonitrile butadiene styrene (ABS). The device may also be made in variations in which said components are made of various metals such as, but not limited to, tool grade steel and brass, and in various grades of said materials. In some embodiments, the securing pins (or fasteners) may be made of various materials of applicability, such as but not limited to steel, aluminum alloy, and stainless steel, and in various grades of said materials. The securing pins may also be produced from various plastics such as but not limited to high-density polyethylene (HDPE), polyamide-imide (PAI), and polychlorotrifluoroethylene (PCTFE). The compression sleeve may be made of various materials of applicability, such as but not limited to neoprene, ethylene propylene diene monomer (EPDM) rubber, and nitrile butadiene rubber (NBR). The compression sleeve may be of various densities. The compression sleeve may or may not feature a conical shape. The compression sleeve may or may not be ribbed to aid its grip upon a hosting bolt. The open slot of the compression sleeve of the device may be of various gap distances. In other embodiments, the Sliding Locking Nut Device may include various other textures on the interior planes of its compression sleeve, and with intentions of aiding grip upon a hosting bolt, such as but not limited to raised studs and corrugated patterns. The device can be made in variations that are twist-activated instead of use and inclusion of its lever.

In one embodiment, a user may apply the Sliding Locking Nut Device upon a bolt by inserting its structure upon said bolt. The user may then simply push the lever of the device downward towards its base, which will force the compression sleeve to make frictional contact upon the bolt. In a non-limiting example, the Sliding Locking Nut Device may be used to secure a toilet seat upon a toilet base. After the bolts of the seat are fitted through the apertures of the toilet base, a user may take the device with its lever in the UP position and slide the device upon a bolt. By depressing the lever towards the base (moving it to the DOWN position) of the device, the interior compression sleeve may substantially compress about the circumference of the inserted bolt, thereby completely drawing the bolt within the device, which may substantially secure the toilet seat structure upon the toilet base. Should the toilet seat need to be removed from the toilet base, a user may simply lift the lever of the device, which may release the interior compression sleeve, thus allowing the seat to be removed for cleaning, cleaning of the toilet base, and/or for replacement of said seat. In other non-limiting examples, the Sliding Locking Nut Device may be used in a multitude of relevant applications.

In some embodiments, an easy-to-use Sliding Locking Nut Device, may comprise of an outer cylinder (the Base), an inner compression sleeve and a lever, wherein said device uses compression to secure upon a hosting bolt. The device may be comprised of an internal, conical-shaped compression sleeve produced from a pliable, durable rubber that may be compressed upon and released from a hosting bolt utilizing leverage applied by a lever. The side walls of the compression sleeve feature an approximate 100-degree angle, which causes the conical shape. The base may be columnar in shape and one end features a flange, and a bracket extends from the base at the same end as the flange. Located within the sidewall of the base may be a slot. The conical-shaped compression sleeve may be located within the base. There may be a vertical slot in the compression sleeve. On the opposite side of the compression sleeve from the slot may include an extending tab. During compression the edges of the vertical slot may move toward one another. A lever may be featured, and one end includes two extending walls. In the extending walls of the lever may be two sets of holes (for a total of 4 holes). The extending tab on the compression sleeve may stick through the slot on the base. The indentation within the extending tab may ride up and down within the vertical walls of the slot. The top holes of the lever align with the hole within the Bracket upon the base, and a metal pin is inserted within the holes to hold the lever and base together. A connecting rod may fasten to the bottom holes in the lever with use of a metal pin. The opposite end of the connecting rod may fasten to the compression sleeve's extending tab which may protrude through the slot in the base. Now the lever may be in communication with the base and the compression sleeve via the connecting rod. When the lever is pulled up, the compression sleeve may be high within the base and relaxed. When the lever is pushed down, the compression sleeve may be lowered within the base and constricts tightly on the hosting bolt. The downward constricting motion of the compression sleeve pulls the hosting bolt deep within the base and may constrict upon the hosting bolt's shaft. The compression upon and release from a hosting bolt can all be done with no tools.

The present invention will now be described in detail with reference to embodiments thereof as illustrated in the accompanying drawings.

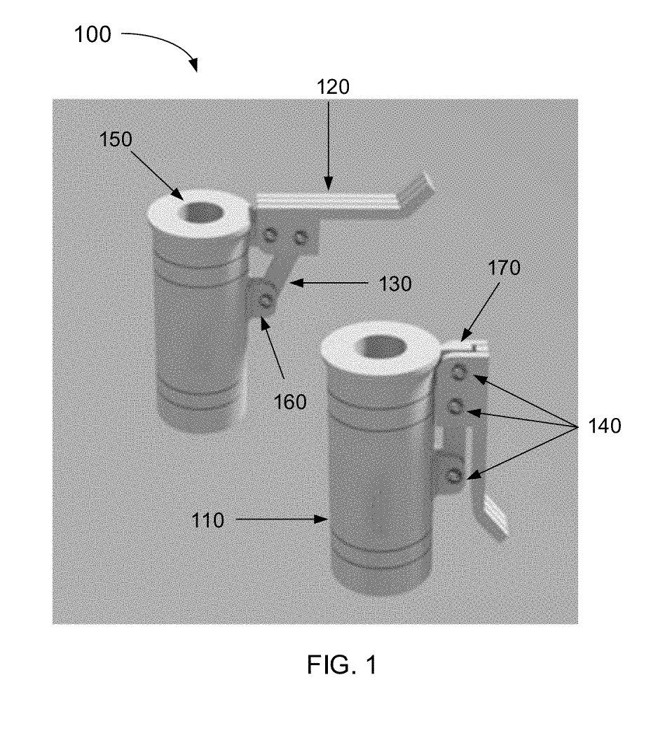

FIG. 1 is an illustration of an exemplary sliding locking nut device 100, in accordance with an embodiment of the present invention. In the present embodiment shown, the sliding locking nut device 100 may comprise a base portion 110, a lever implement 120, a connecting rod 130, at least three (3) pins 140, an orifice 150, a compression sleeve tab 160, and extending bracket part 170. The base portion 110 may include a cylindrical shaped sliding nut having an interior chamber. The lever implement 120 may attach to the extending bracket part 170 using at least one (1) pin. The connecting rod 130 may attach the lever implement 120 to the compression sleeve tab 160. At least one (1) pin 140 may secure the lever implement 120 to the extending bracket, at least one (1) pin 140 to the connecting rod 130, at least one (1) pin 140 to the compression sleeve tab 160. The orifice 150 may provide a passageway for a bolt. The compression sleeve tab 160 may extend out of a slot segment of the base portion 110.

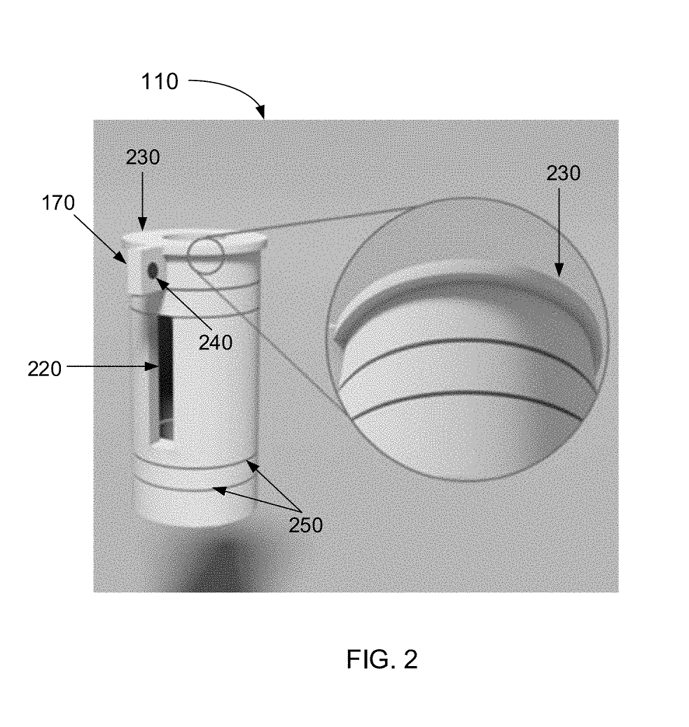

FIG. 2 is an illustration of an exemplary base portion 110, in accordance with an embodiment of the present invention. In the present embodiment shown, the base portion may include an extending bracket 170, a slot segment or open length-wise column 220, a flange section 230, an aperture 240 and a surface texture 250. The lever 120 may attach to the extending bracket part 170. The pins 140 may secure the lever 120 to the extending bracket part 170, the connecting rod 130 and the compression sleeve tab 160. The compression sleeve tab 160 may extend out of the slot segment 220 where the connecting rod 130 may attach the lever 120 to the compression sleeve tab 160. The surface texture 250 may aid a user in gripping the device during use. The flange section 230 may be disposed about the circumference of one (1) end of the device. On the same endpoint of the device (as the flange), there may be included an extending bracket part 170. An aperture 240 may be featured through the extending bracket part 170. Directly below the extending bracket part 170 is the open length-wise column 220, through which the compression sleeve tab 160 may extend out.

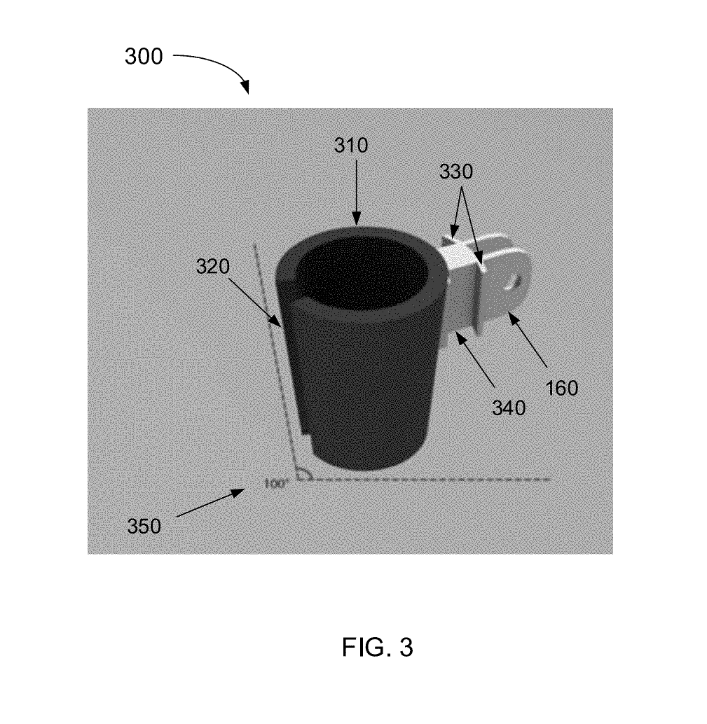

FIG. 3 is an illustration of an exemplary compression sleeve 300, in accordance with an embodiment of the present invention. In the present embodiment shown, the compression sleeve 300 may include a compression sleeve sidewall 310, an open slot 320, an indentation tab guide 330, a tab indentation 340, an angle of the compression sleeve's conical shape 350, and the compression sleeve tab 160. The indentation tab guide 330 aligns the tab indentation 340 along the walls of the slot segment 220, wherein the indentation tab guide 340, guides the movement of the compression sleeve tab 160 along the walls of the slot segment 220 during a compression and relaxation of the compression sleeve sidewall 310. The compression sleeve sidewall 310 may be made of, but not limited to, neoprene or another pliable durable rubber, and in a conical shape that narrows towards the aperture of the base portion that is at the opposite endpoint of the flange. The compression sleeve sidewall 310 may be compressed upon and released from a bolt utilizing leverage applied by the lever implement 120. The sidewalls 310 of the compression sleeve 300 feature a proximately 100-degree angle, which causes the conical shape. The conical-shaped compression sleeve sidewall 310 may be located within the base portion 110.

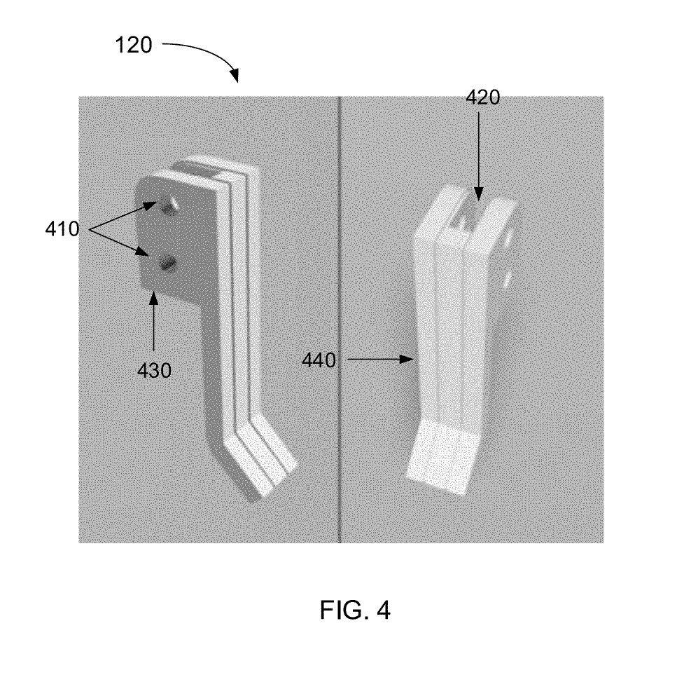

FIG. 4 is an illustration of an exemplary lever implement 120, in accordance with an embodiment of the present invention. In the present embodiment shown, the lever implement 110 includes apertures 410, a lever slot 420, a lever bracket 430 and a lever handle 440. The lever implement 120, which may be made of, but not limited to, nylon polyamide (PA) material, may include a lever bracket 430, which is sized in length and width for its application upon the extended bracket 210 on the base portion 110 of the device. The lever bracket 430 may include two (2) axles, the topmost portion of the axles may connect to the extending bracket part 170 with a pin 140. The connecting rod 130, may be made of, but not limited to, the same nylon polyamide (PA) material, may connect by pin 140 to the remaining axle of the lever implement 120 at one (1) end, and the opposite end of the connecting rod 130 may connect to the tab of the compression sleeve by a pin 140. The pins 140 may be made of, but not limited to, a hardware-grade steel.

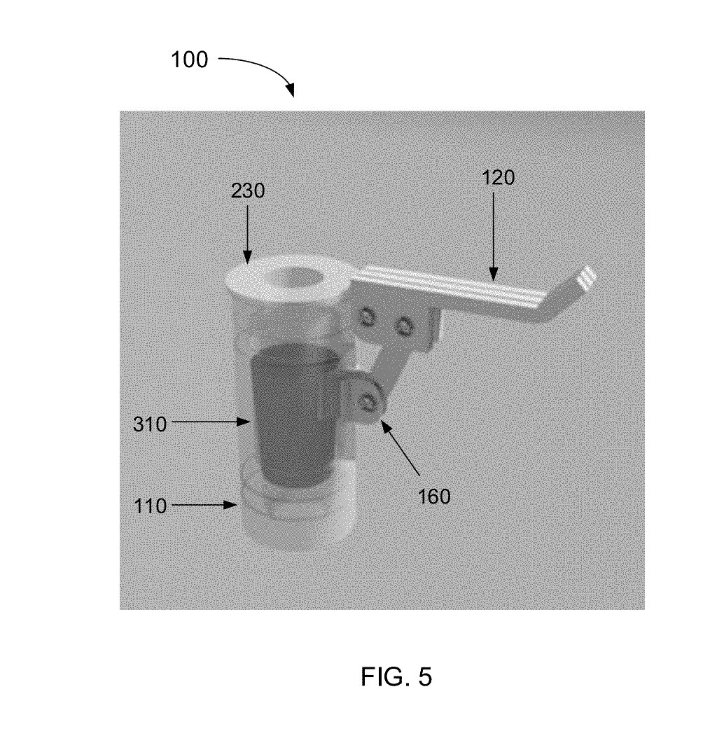

FIG. 5 is an illustration of an exemplary see-through view of the device 100, wherein the lever 120 is in the up position, in accordance with an embodiment of the present invention. In the present embodiment shown, the compression sleeve sidewall 310 is inside the base portion 110 in a relaxed position, wherein the lever is in the up position. The compression sleeve sidewall 310 may be made of neoprene, and in a conical shape that narrows towards the aperture of the base portion 110 that is at the opposite endpoint of the flange section 230. Extending from the compression sleeve sidewall 310, and through the open length-wise column 220 of the base portion, is the compression sleeve tab 160 which may be made of, but not limited to, nylon polyamide (PA). For attachment to the extending bracket part 170 and which may extend from the top area of the base portion 110 may include the lever implement 120, which may be made of, but not limited to, nylon polyamide (PA) material.

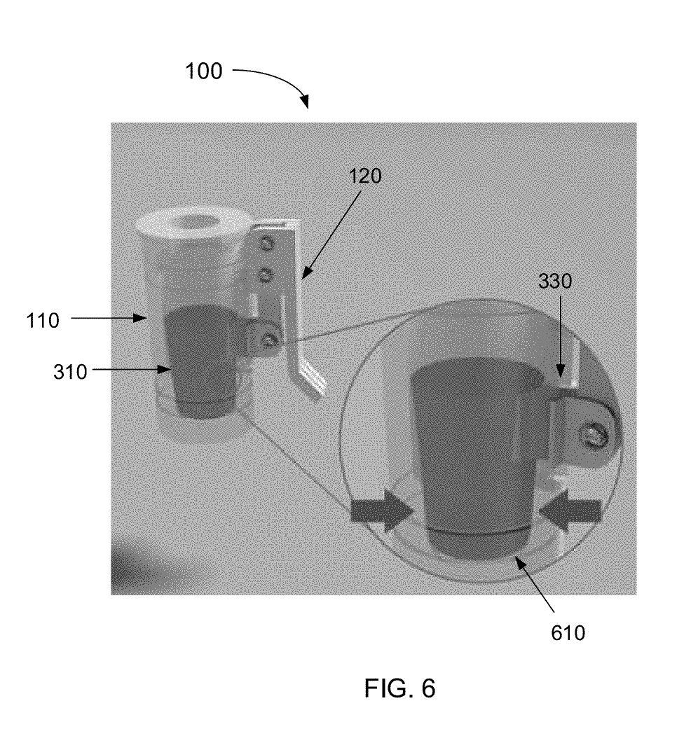

FIG. 6 is an illustration of an exemplary see-thru view of the device 100, wherein the lever implement 120 is in the down position, in accordance with an embodiment of the present invention. In the present embodiment shown, when the lever implement 120 is in the down position, which may cause the compression sleeve tab 160 to be lowered through the slot segment 220 which causes the compression sleeve sidewall 310 to substantially constrict. When the compression sleeve tab 160 is at the bottom of the slot segment 220, the compression sleeve sidewall 310 may be fully compressed. The oversized arrows may indicate the compression sleeve sidewall 310 is compressing. The opposing walls of the open slot 320 in the compression sleeve sidewall 310 may be pushed toward one another. This may cause the compression sleeve sidewall 310 to substantially compress onto the shaft of a bolt in a generally tight manner.

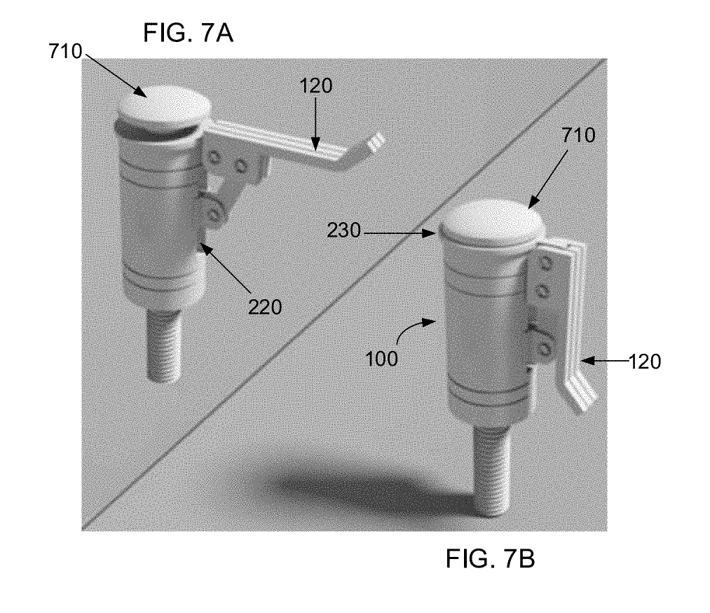

FIG. 7A and FIG. 7B is an illustration of an exemplary sliding locking nut device 100 upon a bolt 710, in accordance with an embodiment of the present invention. In the present embodiment shown, the sliding locking nut device 100 comprises a bolt operable for engaging a removable member to a stationary member. In FIG. 7A, the lever 120 is in the up position, the sidewall 310 of the compression sleeve 300 is relaxed and the bolt 710 is a bit up. In FIG. 7B, the lever 120 is in the down position, the sidewall 310 of the compression sleeve 300 has been compressed, and the bolt 710 has been pulled down tight against the flange 230. It will generally stay that way until the lever implement 120 is raised or lifted.

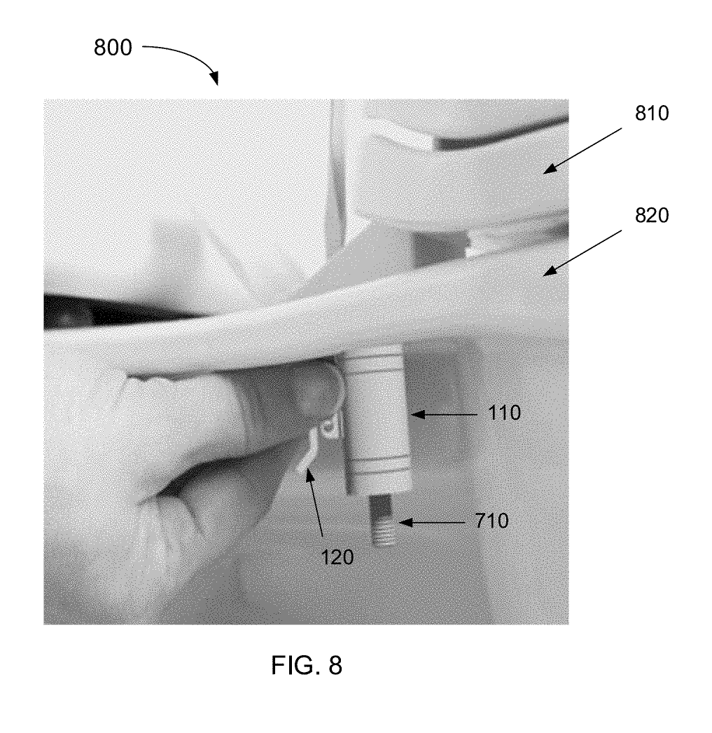

FIG. 8 is an illustration 800 of an exemplary sliding locking nut device 100 in use to attach a toilet seat 810 to a toilet bowl 820, in accordance with an embodiment of the present invention. In the present embodiment shown, the base 110 of device 100 may clamp upon the bolt 710 by pulling down on the lever 120 to secure the toilet seat 810 to the toilet bowl 820. To detach the toilet seat 810 from the toilet bowl 820, a user may simply lift the lever 120, which may loosen the compressed sidewall, with no tools required.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a locking mechanism that can take the place of a standard securing nut, and which may be applied to and removed from a hosting bolt without tools according to the present invention, will be apparent to those skilled in the art. Various aspects of the invention have been described above by way of illustration, and the specific embodiments disclosed are not intended to limit the invention to the particular forms disclosed. The particular implementation of the locking mechanism that can take the place of a standard securing nut, and which can be applied to and removed from a hosting bolt without tools may vary depending upon the particular context or application. By way of example, and not limitation, the locking mechanism that can take the place of a standard securing nut, and which can be applied to and removed from a hosting bolt without tools described in the foregoing were principally directed to toilet seat implementations; however, similar techniques may instead be applied to securing a detachable member to stationary member in a way that substantially secures the detachable member but also allows the detachable member to be separated from and re-attached to the stationary member, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A device comprising:
a base portion, wherein said base portion is operable for accepting or fitting upon a bolt;
an interior chamber disposed within said base portion;
a compression sleeve disposed within said interior chamber, wherein said compression sleeve is operable for compressing about the circumference of the bolt; and
a lever implement, in which said lever implement is operable for at least one of, compressing and relaxing said compression sleeve, wherein lifting of said lever implement relaxes said compression sleeve, and wherein depressing said lever implement towards said base portion compresses said compression sleeve to constrict upon the bolt and generally secure the bolt.

2. The device of claim 1, in which said base portion comprises an extending bracket part, wherein said extending bracket part is configured to attach to said lever implement.

3. The device of claim 2, in which said compression sleeve comprises at least a compression sleeve tab, wherein said compression sleeve tab is configured to engage with said lever implement.

4. The device of claim 3, in which said compression sleeve further comprises at least a compression sleeve sidewall disposed within said interior chamber, wherein said compression sleeve sidewall is into engagement with said compression sleeve tab.

5. The device of claim 4, in which said base portion further comprises a slot segment, wherein said slot segment is an open length-wise column along a portion of said base portion, and wherein compression sleeve tab extends out of said slot segment.

6. The device of claim 5, in which said compression sleeve further comprises at least an indentation tab guide, wherein said indentation tab guide is configured to guide said compression sleeve tab along said slot segment during compression or relaxation of said compression sleeve.

7. The device of claim 6, in which said compression sleeve further comprises at least an open slot.

8. The device of claim 7, in which said base portion further comprises a surface texture being configured to aid a user in gripping the device during use.

9. The device of claim 8, in which said lever implement comprises at least two axles, wherein a topmost portion of said at least two axles is configured to engage with said extending bracket part with a pin.

10. The device of claim 9, in which said at least two axles further comprises a lowermost portion.

11. The device of claim 10, further comprising a connecting rod, in which said connecting rod comprises a first end portion that is configured to engage said compression sleeve tab.

12. The device of claim 11, in which said connecting rod further comprises a second end portion that is configured to engage a lower portion of said at least two axles.

13. The device of claim 12, in which said base portion further comprises an orifice disposed on a central portion of said base portion, wherein said orifice is operable for accepting said bolt.

14. The device of claim 13, in which said base portion is a cylindrical shaped sliding nut.

15. The device of claim 14, further comprising a bolt, wherein said bolt is operable for engaging a removable member to a stationary member.

16. The device of claim 15, in which said removable member comprises at least a toilet seat, and in which said stationary member comprises at least a toilet bowl.

17. A device consisting of:
means for housing a bolt;
means for accepting the bolt;
means for securing an inserted bolt;
means for accommodating said securing means;
means for compressing or relaxing said securing means, wherein depressing said compressing means towards said accepting means compresses said securing means to constrict upon said inserted bolt and generally secure said inserted bolt;
means for engaging said compressing means to said housing means;
means for engaging said compressing means to said securing means; and
means for guiding a movement of said securing means.

18. A device comprising:
a base portion, wherein said base portion is operable for accepting or fitted upon a bolt;
an interior chamber disposed within said base portion;
a compression sleeve disposed within said interior chamber, wherein said compression sleeve is operable for compressing about the circumference of an said bolt;
a lever implement, in which said lever implement is configured to at least one of, compress and relax said compression sleeve, wherein a lifting of said lever implement relaxes said compression sleeve, and wherein depressing said lever implement towards said base portion compresses said compression sleeve to constrict upon said bolt and generally secure said bolt;
an extending bracket part, wherein said extending bracket part is configured to attach to said lever implement;
a connecting rod, in which said connecting rod comprises a first end portion that is configured to engage said compression sleeve tab; and
wherein said bolt is operable for engaging a removable member to a stationary member.

19. The device of claim 18, in which said lever implement comprises at least two axles, wherein a topmost portion of said at least two axles is configured to engage with said extending bracket part with a pin.

20. The device of claim 19, in which said at least two axles further comprises a lowermost portion, and in which said connecting rod further comprises a second end portion that is configured to engage a lower portion of said at least two axles.
